(19) United States
(12) Patent Application Publication
(10) Pub. No.: US 2021/0132932 A1
(43) Pub. Date: May 6, 2021

(54) SMART EQUIPMENT, METHOD USED BY SMART EQUIPMENT, AND SMART LAMP

(71) Applicants: Xin LUO, Shanghai (CN); Charles SHI, Shanghai (CN); Dong XING, Shanghai (CN); Aijun WANG, Shanghai (CN); Jiyong ZHANG, Shanghai (CN)

(72) Inventors: Xin LUO, Shanghai (CN); Charles SHI, Shanghai (CN); Dong XING, Shanghai (CN); Aijun WANG, Shanghai (CN); Jiyong ZHANG, Shanghai (CN)

(73) Assignee: GENERAL ELECTRIC COMPANY, SCHENECTADY, NY (US)

(21) Appl. No.: 16/639,568

(22) PCT Filed: Aug. 15, 2017
(86) PCT No.: PCT/CN2017/097508

§ 371 Date: Feb. 15, 2020

(51) Int. Cl. G06F 8/65; G16Y 40/30; G16Y 10/80; H04L 29/08; H04W 4/80; H05B 47/17

(52) U.S. Cl. CPC G06F 8/65; G16Y 40/30; G16Y 10/80; H05B 47/17; H04L 67/125; H04W 4/80; H04L 67/34

(57) ABSTRACT

The present invention relates to a smart equipment, a method used by a smart equipment, and a smart lamp. The smart equipment comprises a WiFi module and a Bluetooth Low Energy (BLE) module. The BLE module comprises a microcontroller unit (MCU). The WiFi module wirelessly downloads an OTA file. The microcontroller unit divides the OTA file into at least one packages. The Bluetooth Low Energy (BLE) module OTA upgrades a plurality of devices in a mesh network simultaneously by broadcasting the at least one packages.

### FIELD

Embodiments of the invention relate generally to the field of LED lighting. More particularly, the embodiments of the invention relate to a smart equipment, a method used by a smart equipment, and a smart lamp.

### BACKGROUND

As the LED lighting technology is developing, LED lighting devices are becoming more and more widely used in people's lives, among which it is a general trend that LED bulbs, LED tubes and LED spot lights will replace the traditional bulbs, tubes and spot lights.

A Bluetooth low energy (BLE) mesh network may be used in smart lighting and smart home systems. The BLE mesh network is a network that allows for many-to-many communication over Bluetooth radio with low power consumption and high efficiency. For example, a BLE mesh network used for smart lighting may comprise a smart lamp and a plurality of smart bulbs. The plurality of smart bulbs need to be Over-the-air (OTA) upgraded. Over-the-air (OTA) upgrading refers to distributing new firmware to devices.

In the existed techniques, the plurality of devices in the mesh network are OTA upgraded one after another, which would be time-consuming

Therefore, it is necessary to propose a smart equipment and a method that may OTA upgrade a plurality of devices in a more time efficient manner.

### SUMMARY

An objective of the present invention is to provide a smart equipment, a method used by a smart equipment, and a smart lamp.

According to an aspect of the present invention, a smart lamp is provided, comprising: a wireless module for wirelessly downloading an over-the-air file; a microcontroller unit for dividing the over-the-air file into at least one packages; and a Bluetooth Low Energy module for over-the-air upgrading a plurality of devices simultaneously by broadcasting the at least one packages if at least one of the plurality of devices is within one hop range from the smart lamp.

Another aspect of the present invention provides a smart equipment, comprising: a file downloading module for wirelessly downloading a first over-the-air file; and a broadcasting module for over-the-air upgrading a first plurality of devices simultaneously by use of the first over-the-air file.

Another aspect of the present invention provides a method used by a smart equipment, comprising: wirelessly downloading a first over-the-air file; and over-the-air upgrading a first plurality of devices simultaneously by use of the first over-the-air file.

### BRIEF DESCRIPTION OF THE DRAWINGS

The present disclosure can be better understood in light of description of one embodiment of the present disclosure with reference to the accompanying drawings, in which:

FIG. 1 illustrates a diagram of a mesh network in which a plurality of devices are over-the-air upgraded by a smart equipment in accordance with an embodiment of the present invention;

FIG. 2 illustrates a block diagram of a smart equipment in accordance with an embodiment of the present invention;

FIG. 3 illustrates a block diagram of another smart equipment in accordance with an embodiment of the present invention;

FIG. 4 illustrates a block diagram of a further smart equipment in accordance with an embodiment of the present invention;

FIG. 5 illustrates a flow chart for a method used by a smart equipment in accordance with an embodiment of the present invention;

FIG. 6 illustrates a flow chart for broadcasting an over-the-air file in accordance with an embodiment of the present invention;

FIG. 7 illustrates a flow chart for broadcasting an over-the-air file in accordance with an embodiment of the present invention; and

FIG. 8 illustrates a block diagram of a smart equipment in accordance with an embodiment of the present invention.

### DETAILED DESCRIPTION

Unless defined otherwise, the technical or scientific terms used herein should have the same meanings as commonly understood by one of ordinary skilled in the art to which the present disclosure belongs. The terms “first”, “second” and the like in the Description and the Claims of the present application for disclosure do not mean any sequential order, number or importance, but are only used for distinguishing different components. Likewise, the terms “a”, “an” and the like do not denote a limitation of quantity, but denote the existence of at least one. The terms “comprises”, “comprising”, “includes”, “including” and the like mean that the element or object in front of the “comprises”, “comprising”, “includes” and “including” covers the elements or objects and their equivalents illustrated following the “comprises”, “comprising”, “includes” and “including”, but do not exclude other elements or objects.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present disclosure. The various appearances of “an embodiment,” “one embodiment,” or “some embodiments” are not necessarily all referring to the same embodiments. Elements or aspects from an embodiment can be combined with elements or aspects of another embodiment.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

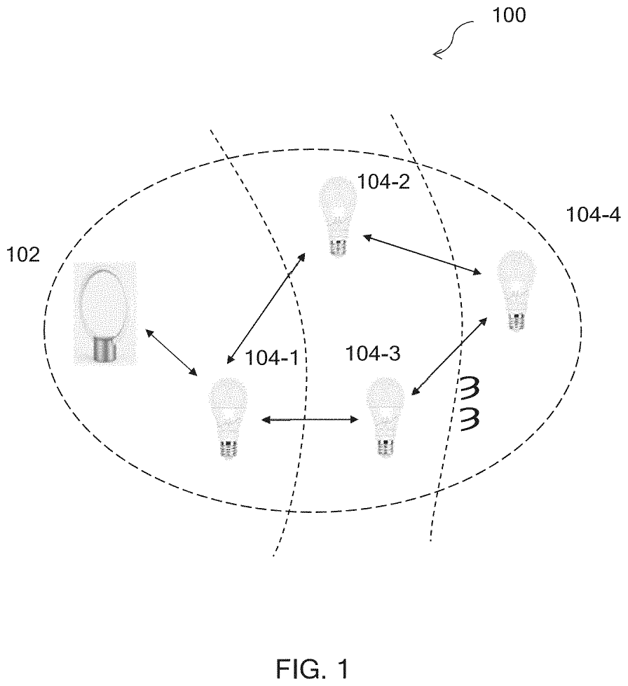

FIG. 1 illustrates a diagram of a mesh network in which a plurality of devices are Over-the-air (OTA) upgraded by a smart equipment in accordance with an embodiment of the present invention. As shown in FIG. 1, the mesh network 100 comprises a smart equipment 102 and a plurality of devices 104-1, 104-2, . . . , 104-N (not shown), where N is an integer that is equal to or greater than one. The plurality of devices 104-1, 104-2, . . . , 104-N are located at different locations in the mesh network 100. As an example, as shown in FIG. 1, device 104-1 is located within one hop range from the smart equipment 102. The one hop range is indicated in FIG. 1 by a dash line nearest to the smart equipment 102. Devices 104-2 and 104-3 are located within two hop range from the smart equipment 102. The one hop range is indicated in FIG. 1 by a dash line second nearest to the smart equipment 102. Device 104-4 is located within three hop range from the smart equipment 102.

The plurality of devices 104-1, 104-2, . . . , 104-N need to be Over-the-air (OTA) upgraded.

In some embodiments, to facilitate OTA upgrading, at least one device of the plurality of devices 104-1, 104-2, . . . , 104-N is located within one hop range from the smart equipment 102. In some embodiments, all of the plurality of devices 104-1, 104-2, . . . , 104-N may be located within one hop range from the smart equipment 102.

In some embodiments, the smart equipment 102 downloads an OTA file, and OTA upgrades the plurality of devices 104-1, 104-2, . . . , 104-N simultaneously by broadcasting the OTA file, where devices that are located beyond one hop distance to the smart equipment 102, for example device 104-4, may also be upgraded. Broadcasting is a concept that, in a mesh network, when one node is broadcasting a message, each of other nodes can receive the message by means of an implement.

In some embodiments, the plurality of devices 104-1, 104-2, . . . 104-N are of the same type.

In some embodiments, the plurality of devices 104-1, 104-2, . . . 104-N may contain more than one type of devices. In this case, the smart equipment 102 downloads a first OTA file, and OTA upgrades a first type of devices simultaneously by broadcasting the first OTA file. The smart equipment 102 downloads a second OTA file that is different from the first OTA file, and OTA upgrades a second type of devices simultaneously by broadcasting the second OTA file. The second type is different from the first type. In some embodiments, the smart equipment 102 may download a third OTA file and upgrade a third type of devices, and so on.

In some embodiments, the downloading of different OTA files may be performed in parallel with, in overlapping with or separated from each other. In some embodiments, the downloading of the OTA files may be performed one after another.

In some embodiments, the OTA upgrading of different types of devices may be performed in parallel with, in overlapping with or separated from each other. In some embodiments, the OTA upgrading of different types of devices may be performed one after another.

In some embodiments, the mesh network 100 is a Bluetooth Low Energy (BLE) mesh network used for smart lighting, the smart equipment 102 may be a smart lamp, and the plurality of devices 104-1, 104-2, . . . , 104-N may be a plurality of smart bulbs 104-1, 104-2, . . . , 104-N. However, the smart equipment 102 may be of other types than the smart lamp, and the plurality of devices 104-1, 104-2, . . . , 104-N may be of other types than the smart bulbs. For example, the smart equipment 102 may be a smart TV, smart refrigerator, a smart air conditioner, a smart washing machine, a smart cleaner, etc. The plurality of devices may be smart cameras, smart sockets, smart speakers, etc.

While there is only one smart equipment 102 shown in FIG. 1, in another embodiment, there may be more than one smart equipments in the mesh network 100.

Compared to the existing OTA upgrading method in a mesh network, embodiments of the present invention may reduce the time required for OTA upgrading a plurality of devices so as to improve efficiency for OTA upgrading. Devices that are located beyond one hop distance from the smart equipment may also be OTA upgraded. For a large mesh network environment, user may have better experience during OTA upgrading. The scope of application of the OTA upgrading technique is increased accordingly.

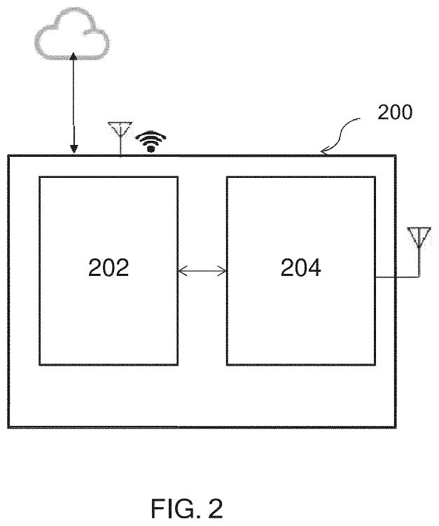

FIG. 2 illustrates a block diagram of a smart equipment in accordance with an embodiment of the present invention. As shown in FIG. 2, the smart equipment 200 comprises a WiFi module 202 and a Bluetooth Low Energy (BLE) module 204. The WiFi module 202 wirelessly downloads an OTA file from a server. The Bluetooth Low Energy (BLE) module 204 OTA upgrades a plurality of devices in a mesh network simultaneously by broadcasting the OTA file.

In some embodiments, to facilitate OTA upgrading, at least one device of the plurality of devices is located within one hop range from the smart equipment 200. In some embodiments, all of the plurality of devices may be located within one hop range from the smart equipment 200.

In some embodiments, at least one device of the plurality of devices is located beyond one hop range from the smart equipment 200. During OTA upgrading, all the plurality of devices may be simultaneously upgraded.

In some embodiments, the WiFi module 202 wirelessly downloads the OTA file upon receiving an instruction from a user terminal. As an example, a user terminal may be a mobile phone. An APP in the mobile phone may be used to interact with the smart equipment 200. The instruction may be sent by a user using the APP.

In some embodiments, the WiFi module 202 wirelessly downloads the OTA file at a timing or time period predetermined by a user terminal. As an example, a user may use an APP in a mobile phone to interact with the smart equipment 200, and set a timing or a time period in the APP that is used by smart equipment 200 to download the OTA file. As an example, the timing may be 10 AM every Monday, 12 PM on the first day of every month, etc. As another example, the time period may be 8 AM to 9 AM every Saturday, 1 PM to 3 PM on the 15th day of every month, every two days, etc.

In some embodiments, the WiFi module 202 wirelessly downloads the OTA file upon determining the OTA file is available for downloading. As an example, the smart equipment 200 may periodically check the availability of the OTA file. As another example, the smart equipment 200 may check the availability of the OTA file in a real-time manner.

Upon the downloading of the OTA file is completed, The Bluetooth Low Energy (BLE) module 204 is notified by the WiFi module 202 to OTA upgrade a plurality of devices in a mesh network simultaneously by broadcasting the OTA file.

In some embodiments, the plurality of devices may contain more than one type of devices. In this case, the WiFi module 202 downloads a first OTA file, and the BLE module 204 upgrades a first type of devices simultaneously by broadcasting the first OTA file. The WiFi module 202 also downloads a second OTA file that is different from the first OTA file, and the BLE module 204 OTA upgrades a second type of devices simultaneously by broadcasting the second OTA file. The second type is different from the first type. In some embodiments, the WiFi module 202 may download a third OTA file, and the BLE module 204 upgrade a third type of devices, and so on. The third type is different from the first type or the second type.

In some embodiments, the downloading of different OTA files may be performed in parallel with, in overlapping with, or separated from each other. In some embodiments, the downloading of OTA files may be performed one after another.

In some embodiments, the OTA upgrading of different types of devices may be performed in parallel with, in overlapping with or separated from each other. In some embodiments, the OTA upgrading of different types of devices may be performed one after another.

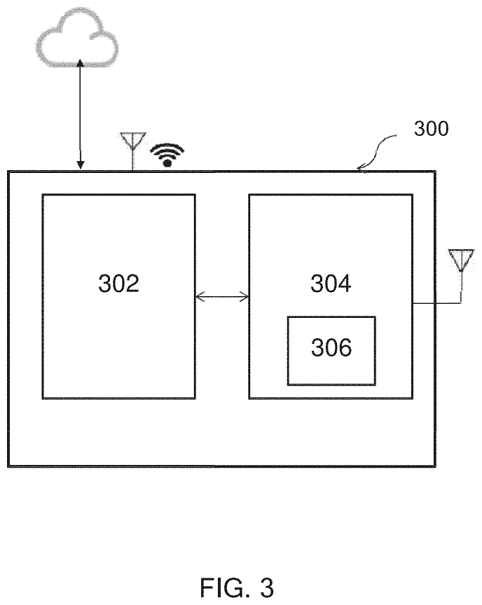

FIG. 3 illustrates a block diagram of a smart equipment in accordance with an embodiment of the present invention. As shown in FIG. 3, the smart equipment 300 comprises a WiFi module 302 and a Bluetooth Low Energy (BLE) module 304. The BLE module 304 comprises a microcontroller unit (MCU) 306. The WiFi module 302 wirelessly downloads an OTA file. The microcontroller unit 306 divides the over-the-air file into at least one packages. The Bluetooth Low Energy (BLE) module 304 OTA upgrades a plurality of devices in a mesh network simultaneously by broadcasting the at least one packages.

In some embodiments, to facilitate OTA upgrading, at least one device of the plurality of devices is located within one hop range from the smart equipment 300. In some embodiments, all of the plurality of devices may be located within one hop range from the smart equipment 300.

In some embodiments, at least one device of the plurality of devices is located beyond one hop range from the smart equipment 300. During OTA upgrading, all the plurality of devices may be simultaneously upgraded.

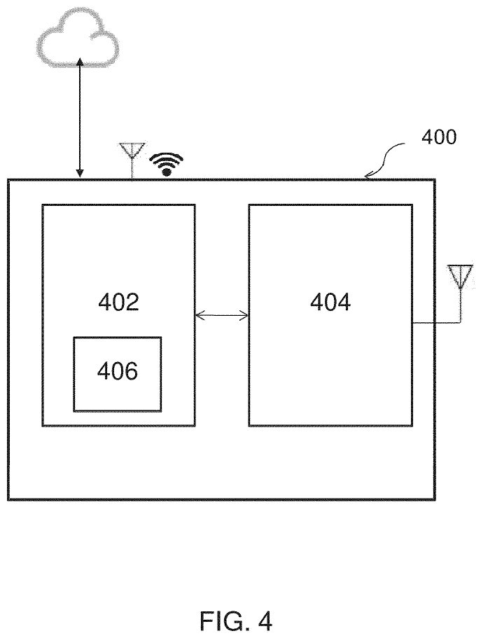

FIG. 4 illustrates a block diagram of a smart equipment in accordance with an embodiment of the present invention. As shown in FIG. 4, the smart equipment 400 comprises a WiFi module 402 and a Bluetooth Low Energy (BLE) module 404. The WiFi module 402 comprises a microcontroller unit (MCU) 406. The WiFi module 402 wirelessly downloads an OTA file. The microcontroller unit 406 divides the over-the-air file into at least one packages. The Bluetooth Low Energy (BLE) module 404 OTA upgrades a plurality of devices in a mesh network simultaneously by broadcasting the at least one packages.

In some embodiments, to facilitate OTA upgrading, at least one device of the plurality of devices is located within one hop range from the smart equipment 400. In some embodiments, all of the plurality of devices may be located within one hop range from the smart equipment 400.

In some embodiments, at least one device of the plurality of devices is located beyond one hop range from the smart equipment 400. During OTA upgrading, all the plurality of devices may be simultaneously upgraded.

In some embodiments, while not shown in any of the figures, the microcontroller unit may be contained in the smart equipment, but separated from either of the WiFi module or the BLE module. The microcontroller unit is used to divide the received OTA file into at least one packages for broadcasting.

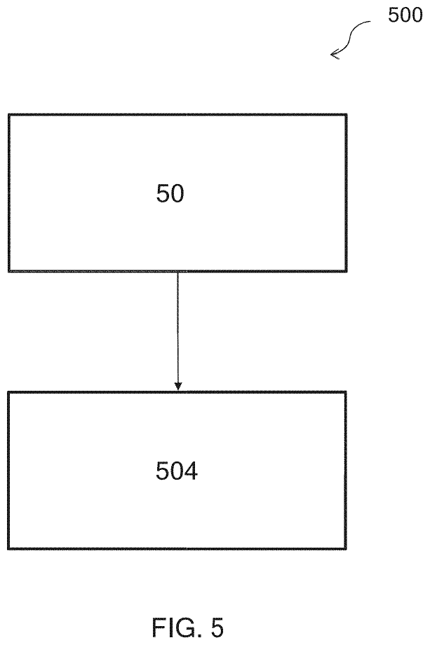

FIG. 5 illustrates a flow chart for a method 500 used by a smart equipment in accordance with an embodiment of the present invention. Method 500 is not meant to be limiting and may be used in other applications. As shown in FIG. 5, in Step 502, a over-the-air (OTA) file is wirelessly downloaded. In Step 504, a plurality of devices are Over-the-air (OTA) upgraded simultaneously by broadcasting the OTA file.

In some embodiments, to facilitate OTA upgrading, at least one device of the plurality of devices is located within one hop range from the smart equipment. In some embodiments, all of the plurality of devices may be located within one hop range from the smart equipment.

In some embodiments, at least one device of the plurality of devices is located beyond one hop range from the smart equipment. During OTA upgrading, all the plurality of devices may be simultaneously upgraded.

In some embodiments, Step 502 is performed upon receiving an instruction from a user terminal. As an example, the instruction may be sent by a user using an APP in a mobile phone, where the APP may be used to interact with the smart equipment.

In some embodiments, Step 502 is performed at a timing or time period predetermined by a user terminal. As an example, a user may use an APP in a mobile phone to interact with the smart equipment, and set a timing or a time period in the APP that is used by smart equipment to download the OTA file. As an example, the timing may be 10 AM every Monday, 12 PM on the first day of every month, etc. As another example, the time period may be 8 AM to 9 AM every Saturday, 1 PM to 3 PM on the 15th day of every month, every two days, etc.

In some embodiments, Step 502 is performed upon determining the OTA file is available for downloading. As an example, the smart equipment may periodically check the availability of the OTA file. As another example, the smart equipment may check the availability of the OTA file in a real-time manner.

In some embodiments, the plurality of devices may contain more than one type of devices. In this case, the smart equipment downloads a first OTA file, and upgrades a first type of devices simultaneously by broadcasting the first OTA file. The smart equipment also downloads a second OTA file that is different from the first OTA file, and OTA upgrades a second type of devices simultaneously by broadcasting the second OTA file. The second type is different from the first type.

In some embodiments, the smart equipment may download a third OTA file and upgrade a third type of devices, and so on. The third type is different from the first type or the second type.

In some embodiments, the downloading of different OTA files may be performed in parallel with, in overlapping with, or separated from each other. In some embodiments, the downloading of OTA files may be performed one after another.

In some embodiments, the OTA upgrading of different types of devices may be performed in parallel with, in overlapping with or separated from each other. In some embodiments, the OTA upgrading of different types of devices may be performed one after another.

In some embodiments, there may be more than one smart equipments in the mesh network.

In some embodiments, the mesh network is a Bluetooth Low Energy (BLE) mesh network used for smart lighting. The smart equipment may be a smart lamp, and the plurality of devices may be a plurality of smart bulbs. However, the smart equipment may be of other types than the smart lamp, and the plurality of devices may be of other types than the smart bulbs. For example, the smart equipment 102 may be a smart TV, smart refrigerator, a smart air conditioner, a smart washing machine, a smart cleaner, etc. The plurality of devices may be smart cameras, smart sockets, smart speakers, etc.

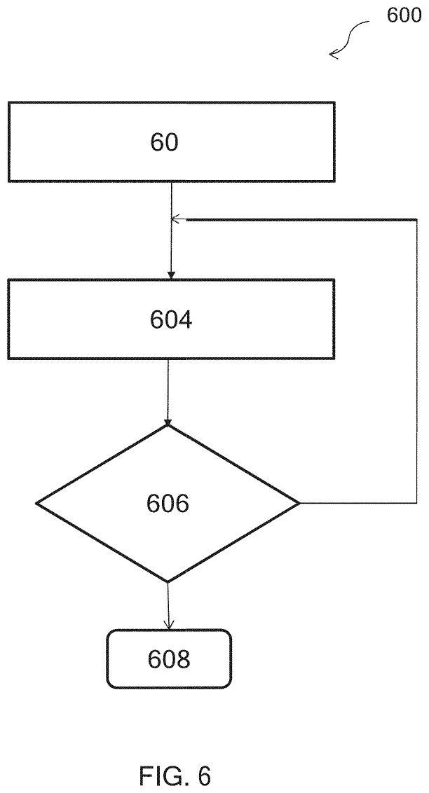

FIG. 6 illustrates a flow chart of a process 600 for broadcasting an over-the-air file in accordance with an embodiment of the present invention. The process 600 comprises: dividing the over-the-air file into M packages, where M is an integer equal to or greater than 1 (Step 602); broadcasting the m-th package to the plurality of devices and rebroadcasting the package when the m-th package is not received by any of the plurality of devices until the m-th package has been received by all of the plurality of devices, where m=1, . . . , M (Step 604). The process 600 further comprises determining whether all of the at least one packages have been broadcast, i.e., whether m is equal to M (Step 606). For Step 606, if not all packages have been broadcast, then m is incremented, i.e., m++, and the process 600 flows back to Step 604 to broadcast a next package. If all of the M packages have been broadcast, the process 600 ends in block 608.

In some embodiments, upon broadcasting a package to a plurality of devices, each device will provide a feedback information indicating whether the package has been received by the device. For example, the device may provide an ACK signal to the smart equipment upon receiving the package. If no ACK signal is received from a particular device during a predetermined period, the smart equipment may determine the package is not successfully received by the particular device and rebroadcast the package again until receiving ACK signals from all devices. As another example, the device may provide an NACK signal to the smart equipment when the package is not received. When the smart equipment receives at least one NACK signal, the smart equipment rebroadcast the package again until no NACK signal is received for the package. Then the flow moves on to broadcast a next package. The flow repeats until all of the at least one packages have been received by all of the plurality of devices.

In some embodiments, upon broadcasting a package to a plurality of devices, each device will provide a feedback information whether the package is received or not. For example, the device may provide an ACK signal to the smart equipment upon receiving the package and provide an NACK signal to the smart equipment when the package is not received. Similarly, when the smart equipment receives at least one NACK signal, the smart equipment rebroadcast the package again until no NACK signal is received for the package. Then the flow moves on to broadcast a next package. The flow repeats until all of the at least one packages have been received by all of the plurality of devices. Other methods may also be contemplated and covered by the present disclosure.

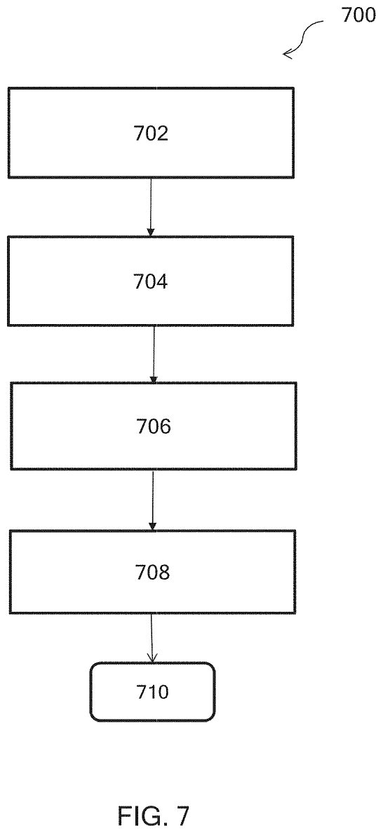

FIG. 7 illustrates a flow chart of a process 700 for broadcasting an over-the-air file in accordance with an embodiment of the present invention. The process 700 comprises: Step 702 for dividing the over-the-air file into at least one packages; Step 704 for broadcasting each of the at least one packages to all of the plurality of devices; Step 706 for determining which packages have not been received by any of the plurality of devices; and Step 708 for rebroadcasting the packages that are not received by any of the plurality of devices to all of the plurality of devices until all the packages have been received by all of the plurality of devices. If all of the at least one packages have been broadcast, the process 700 ends in block 710.

More particularly, there are N devices, and the over-the-air file is divided into M packages. First, the first package is broadcast. Then, the next package is broadcast until all the M packages have been broadcast. Assuming package 1 is not received by Device 1, package 2 is not received by Device 3, and package 5 is not received by Device N, then in Step 708, package 1, package 2, and package 5 are rebroadcast to all the devices 1-N. The broadcast ends only when all the M packages have been received by all the N devices.

In some embodiments, upon broadcasting a package to a plurality of devices, each device will provide a feedback information indicating whether the package has been received by the device. For example, the device may provide an ACK signal to the smart equipment upon receiving the package, or provide an NACK signal when the package is not received.

In some embodiments, upon broadcasting a package to a plurality of devices, each device will provide a feedback information whether the package is received or not. For example, the device may provide an NACK signal to the smart equipment when the package is not received, and provide any ACK signal if the package is received.

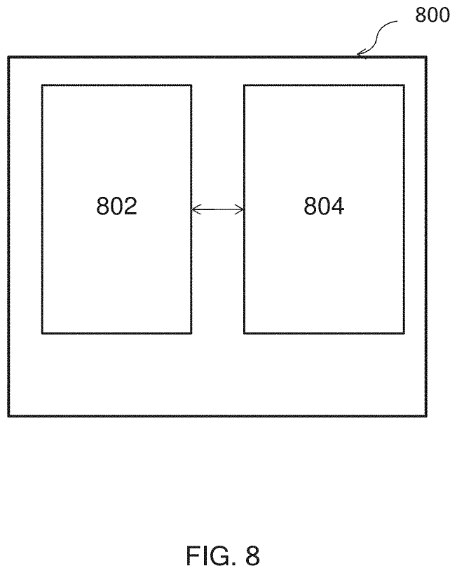

FIG. 8 illustrates a block diagram of a smart equipment 800 in accordance with an embodiment of the present invention. As shown in FIG. 8, a smart equipment 800 comprises a file downloading module 802 and a broadcasting module 804. The file downloading module 802 wirelessly downloads an over-the-air (OTA) file. The broadcasting module 804 over-the-air upgrades a plurality of devices simultaneously by broadcasting the OTA file. The smart equipment 800 may be implemented as electronic hardware, computer software, or combinations of both.

Those of skill would further appreciate that the various illustrative logical blocks, configurations, modules, circuits, and steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It is to be understood that specifics in the aforementioned examples may be used anywhere in one or more embodiments. For instance, all optional features of the electronic device described above may also be implemented with respect to either of the methods or the computer-readable medium described herein. Furthermore, although flow diagrams and/or state diagrams may have been used herein to describe embodiments, the present disclosure is not limited to those diagrams or to corresponding descriptions herein. For example, flow need not move through each illustrated box or state or in exactly the same order as illustrated and described herein.

Although for the descriptions of FIG. 1 to FIG. 8, the present invention has been set forth in combination with specific embodiments, the person skilled in the art shall understand that many modifications and variations may be made to the present invention. Therefore, it should be recognized that the intention of the claims is to cover all these modifications and variations within the real concept and range of the present invention. Accordingly, it is the following claims including any amendments thereto that define the scope of the present disclosure.

1. A smart lamp, comprising:
a wireless module for wirelessly downloading an over-the-air file;
a microcontroller unit for dividing the over-the-air file into at least one packages; and
a Bluetooth Low Energy module for over-the-air upgrading a plurality of devices simultaneously by broadcasting the at least one packages if at least one of the plurality of devices is within one hop range from the smart lamp.

2. The smart lamp as in claim 1, wherein the wireless module is to wirelessly download the over-the-air file at any of the following timings:
upon receiving an instruction from a user terminal;
at a timing or time period predetermined by a user terminal; or
upon determining the over-the-air file is available for downloading.

3. The smart lamp as in claim 1, wherein said Bluetooth Low Energy module comprises a broadcasting module for broadcasting all of the at least one packages, the broadcasting comprising:
for each package,
broadcasting the package to the plurality of devices; and
rebroadcasting the package when the package is not received by any of the plurality of devices until the package has been received by all of the plurality of devices.

4. The smart lamp as in claim 1, wherein said Bluetooth Low Energy module comprises a broadcasting module for:
broadcasting each of the at least one packages to all of the plurality of devices;
determining which packages have not been received by any of the first plurality of devices; and
rebroadcasting the packages that are not received by any of the plurality of devices to all of the plurality of devices until the at least one packages have all been received by all of the plurality of devices.

5. A smart equipment, comprising:
a file downloading module for wirelessly downloading a first over-the-air file; and
a broadcasting module for over-the-air upgrading a first plurality of devices simultaneously by use of the first over-the-air file.

6. The smart equipment as in claim 5, wherein the file downloading module is to wirelessly download the first over-the-air file at any of the following timings:
upon receiving an instruction from a user terminal;
at a timing or time period predetermined by a user terminal; or
upon determining the first over-the-air file is available for downloading.

7. The smart equipment as in claim 5, wherein said upgrading the first plurality of devices simultaneously comprises broadcasting the first over-the-air file if at least one of the first plurality of devices is within one hop range from the smart equipment.

8. The smart equipment as in claim 5, wherein the first plurality of devices comprises at least one device that is located beyond one hop range from the smart equipment.

9. The smart equipment as in claim 7, wherein said broadcasting the first over-the-air file comprises:
dividing the first over-the-air file into at least one packages;
broadcasting all of the at least one packages, comprising:
for each package,
broadcasting the package to the first plurality of devices; and
rebroadcasting the package when the package is not received by any of the first plurality of devices until the package has been received by all of the first plurality of devices.

10. The smart equipment as in claim 7, wherein said broadcasting the first over-the-air file comprises:
dividing the first over-the-air file into at least one packages;
broadcasting each of the at least one packages to all of the first plurality of devices;
determining which packages have not been received by any of the first plurality of devices; and
rebroadcasting the packages that are not received by any of the first plurality of devices to all of the first plurality of devices until the at least one packages have all been received by all of the first plurality of devices.

11. The smart equipment as in claim 5, wherein the file downloading module is further to wirelessly download a second over-the-air file, wherein the second over-the-air file being different from the first over-the-air file.

12. The smart equipment as in claim 11, wherein the broadcasting module is further to broadcast the second over-the-air file if at least one of the second plurality of devices is within one hop range from the smart equipment so as to upgrade a second plurality of devices simultaneously, wherein the second plurality of devices being different from the first plurality of devices.

13. A method used by a smart equipment, comprising:
wirelessly downloading a first over-the-air file; and
over-the-air upgrading a first plurality of devices simultaneously by use of the first over-the-air file.

14. The method as in claim 13, wherein said wirelessly downloading the first over-the-air file is performed at any of the following timings:
upon receiving an instruction from a user terminal;
at a timing or time period predetermined by a user terminal; or
upon determining the first over-the-air file is available for downloading.

15. The method as in claim 13, said upgrading the first plurality of devices simultaneously comprises:
broadcasting the first over-the-air file if at least one of the first plurality of devices is within one hop range from the smart equipment.

16. The method as in claim 13, wherein the first plurality of devices comprises at least one device that is located beyond one hop range from the smart equipment.

17. The method as in claim 15, wherein said broadcasting the first over-the-air file comprises:
dividing the first over-the-air file into at least one packages;
broadcasting all of the at least one packages, comprising:
for each package,
broadcasting the package to the first plurality of devices; and
rebroadcasting the package when the package is not received by any of the first plurality of devices until the package has been received by all of the first plurality of devices.

18. The method as in claim 15, wherein said broadcasting the first over-the-air file comprises:
dividing the first over-the-air file into at least one packages;
broadcasting each of the at least one packages to all of the first plurality of devices;
determining which packages have not been received by any of the first plurality of devices; and
rebroadcasting the packages that are not received by any of the first plurality of devices to all of the first plurality of devices until the at least one packages have all been received by all of the first plurality of devices.

19. The method as in claim 13, further comprising wirelessly downloading a second over-the-air file, wherein the second over-the-air file being different from the first over-the-air file.

20. The method as in claim 19, further comprising upgrading a second plurality of devices simultaneously by broadcasting the second over-the-air file if at least one of the second plurality of devices is within one hop range from the smart equipment, wherein the second plurality of devices being different from the first plurality of devices.
